(19) United States
(12) Patent Application Publication
(10) Pub. No.: US 2026/0354616 A1
(43) Pub. Date: Nov. 12, 2026

(54) BREWING UNIT FOR A MACHINE FOR PREPARING COFFEE AND CORRESPONDING MACHINE

(71) Applicant: DE' LONGHI APPLIANCES S.R.L., Treviso (IT)

(72) Inventors: Paolo EVANGELISTI, Treviso (IT); Nicola PIOVAN, Treviso (IT)

(73) Assignee: DE' LONGHI APPLIANCES S.R.L., Treviso (IT)

(21) Appl. No.: 19/491,723

(22) PCT Filed: Jun. 7, 2025
(86) PCT No.: PCT/IT2024/050119

§ 371 Date: Dec. 9, 2025

(30) Foreign Application Priority Data
Jun. 9, 2023 (IT) 102023000011802

(51) Int. Cl. A47J 31/36; A47J 31/10

(52) U.S. Cl. CPC A47J 31/3609; A47J 31/10

(57) ABSTRACT

Brewing unit (10; 210) for an automatic machine (100) for preparing coffee beverages, comprising a brewing chamber (12) closed at the bottom by a first piston (13; 213) and at the top, on the opposite side, by a second piston (14; 214), and an inlet duct (15; 215) for the heated water communicating with an inlet side (12A) of said brewing chamber (12).

### FIELD OF THE INVENTION

The embodiments described here concern a brewing unit for an automatic machine for preparing coffee beverages both at low pressure, without the presence of cream, as required for preparing a “Drip” type coffee beverage, as well as under pressure, with the presence of cream, that is, beverages with the organoleptic characteristics of an “Espresso” type coffee beverage.

### BACKGROUND OF THE INVENTION

Automatic type coffee machines are known capable of preparing both “Drip” type coffee beverages, also known as Americano coffee, and also “Espresso” type coffee beverages.

As known, the two types of beverages, “Espresso” and “Drip”, have to meet certain specific requirements in order to be considered of high quality, which are often in contrast to each other. While in the case of an “Espresso” coffee it is in fact required that a layer of foam, or cream, forms on top of the beverage, having a certain consistency and color, in the case of a “Drip” coffee, it is required that it is free of any air bubbles, as is normally the case with coffee prepared by percolation.

A typical machine capable of selectively preparing one or the other beverage, “Espresso” or “Drip”, comprises a brewing unit provided with a brewing chamber suitable to receive and contain a dose of coffee powder, a circuit for feeding the brewing water by means of which heated water is fed to the brewing chamber, and a single beverage outlet circuit.

A valve unit is connected to the beverage outlet circuit which is distinct and separated from the brewing unit and to which a beverage dispensing duct is connected.

The valve unit comprises, on a first branch, a so called “cream frother” valve used to dispense “Espresso” coffee, the purpose of which is to increase the outlet pressure of the coffee beverage, creating turbulence in the flow, with the consequent formation of air bubbles and foam, which form the cream typical of a good quality Espresso, and, on a distinct second branch, an on-off valve able to be commanded in order to open or close the second branch and therefore direct the beverage directly to the dispensing duct or to the cream frother valve, respectively.

A disadvantage of such a machine is that the brewing unit and the valve unit together have a significant overall size. In addition, the distance and reciprocal dislocation between the two units make it necessary to create the outlet circuit, as well as the two distinct branches, in which the beverage flows, with a winding path that creates turbulence in the flow and therefore can affect the quality of the beverage prepared, especially in the case of “Drip” coffee.

The distance of the cream frother valve from the brewing unit, on the other hand, has a negative effect especially in the preparation of “Espresso” coffee, since the pressure of the beverage along the route that it travels to the cream frother valve can vary, or in any case be difficult to control.

Another disadvantage that characterizes the configuration of the brewing unit and valve unit described above is the difficulty in keeping the ducts in which the beverage has to flow clean.

The temporary dispensing of hot water under pressure does not always guarantee a sufficient degree of cleanliness of the ducts, in which coffee sediments often remain which can cause a difference in the taste of the subsequent beverages dispensed.

Solutions are also known in which the brewing unit and the valve assembly constitute a single assembly. However, to date, these solutions are constructively very complex, not very reliable and difficult to clean.

Documents WO 2014/119414 A1, US 2011/041697 A1 and WO 2021/229622 A1 disclose brewing units of known types.

There is therefore the need to perfect a brewing unit for a machine for preparing coffee and a corresponding machine that can overcome at least one of the disadvantages of the state of the art.

One purpose of the present invention, which corresponds to the technical problem that the Applicant intends to solve, is to provide a brewing unit, simple to manufacture and with limited overall dimensions, which allows to prepare beverages both at low pressure, without the presence of cream, as required for the preparation of a “Drip coffee” type coffee beverage, as well as under pressure, with the presence of cream, that is, beverages with the organoleptic characteristics of an “Espresso” type coffee beverage.

Another purpose of the present invention is to provide a brewing unit which allows to improve the extraction of the beverage, especially, but not only, in the case of an “Espresso” type coffee beverage.

Another purpose of the present invention is to provide an automatic machine for preparing coffee in which the brewing unit is easy to clean, both automatically and also manually.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the technical problem disclosed above in a new and original way, also achieving considerable advantages compared to the state of the prior art, a brewing unit according to the present invention for an automatic machine for preparing coffee beverages comprises a brewing chamber closed at the bottom by a first piston and at the top, on the opposite side, by a second piston, an inlet duct for the heated water communicating with an inlet side of the brewing chamber.

In accordance with one aspect of the present invention, the brewing unit comprises a valve housed inside the first piston or the second piston, and two distinct outlet ducts communicating with an outlet side of the brewing chamber, wherein a first outlet duct is fluidically connected to the valve and dedicated exclusively to the transfer of an “Espresso” type coffee beverage, and a second outlet duct is fluidically connected to an on-off valve external to the brewing chamber and dedicated exclusively to the transfer of a “Drip” type coffee beverage.

According to the present invention, this valve, known as “cream frother” valve in the sector, is preferably housed inside the first piston which, together with the brewing chamber, defines a mobile assembly able to cooperate, during use, with the second piston.

Doing so achieves at least the advantage of creating a particularly compact brewing unit capable of directly supplying at outlet an “Espresso” type or “Drip” type coffee beverage, without the need to provide other circuits downstream.

In accordance with another aspect of the present invention, the brewing unit comprises a decantation chamber created inside a head portion of the first piston, that is, the lower piston, and configured to house a seating in which the valve is contained.

The decantation chamber is particularly useful if preparing a “Drip” type beverage, since it allows an accumulation of the beverage therein, which helps to reduce any bubbles generated during the transit of the water through the powdered substance and any filter.

Moreover, the integration of the valve in the head portion of the first piston significantly simplifies the coffee beverage dispensing circuit, particularly that of the “Espresso” type. Furthermore, the proximity of the valve to the brewing chamber improves the beverage extraction quality and the formation of the layer of foam, or cream.

In accordance with another aspect of the present invention, the outlet ducts communicate with the decantation chamber by means of respective outlet apertures made through in one of the walls of the head portion of the first piston and in a lateral wall of the brewing chamber. A first outlet aperture communicates with the decantation chamber by means of the valve, wherein the second outlet aperture communicates directly with the decantation chamber.

Creating the outlet ducts, or in any case a part thereof, and the outlet apertures on the first piston and on the brewing chamber which form, as stated, an integral assembly facilitates the cleaning, in particular manual, of the components.

In accordance with another aspect of the present invention, the outlet apertures are located at different distances from a bottom wall of the head portion.

In accordance with another aspect of the present invention, the first outlet aperture is located at a greater (or smaller) distance from the bottom wall than the distance which the second outlet aperture is located from the bottom wall.

In this way, for a “Drip” type beverage it is possible to use the entire volume of the decantation chamber.

In accordance with another aspect of the present invention, the outlet apertures are made angularly offset with respect to each other by an offset angle preferably comprised between 1-2° and 180°.

According to some embodiments, the offset angle is comprised between about 5° and about 120°, even more preferably comprised between about 10° and about 90°, better still between about 10° and about 50°.

In accordance with another aspect of the present invention, the seating is made protruding from a peripheral zone of the bottom wall, with a height only slightly lower than that of a lateral wall of the head portion. According to one variant, the seating is made in the thickness of the bottom wall of the head portion.

The present invention also concerns an automatic machine for preparing “Espresso” and “Drip” type coffee beverages, comprising a unit for feeding coffee powder, a brewing unit as described above, a water feed source connected to the inlet duct and a beverage dispensing nozzle connected to the outlet ducts.

In accordance with one aspect of the present invention, the machine comprises a housing configured to receive, in a removable manner, an extraction assembly formed by the brewing chamber and the first piston in which the valve is housed, and generally by all the components integral with the brewing chamber and the first piston.

In accordance with one aspect of the present invention, the housing is provided with first coupling members and the brewing unit is provided with second coupling members, associated with an external wall of the brewing chamber, configured to cooperate with each other in order to guarantee a releasable positioning of the extraction assembly in the housing.

### DESCRIPTION OF THE DRAWINGS

These and other aspects, characteristics and advantages of the present invention will become apparent from the following description of some embodiments, given as a non-restrictive example with reference to the attached drawings wherein:

FIGS. 1-2 are a schematic view of a brewing unit for a machine for preparing coffee, according to the present invention, for dispensing a “Drip” type coffee beverage (FIG. 1) and an “Espresso” type coffee beverage (FIG. 2);

FIG. 3 is a variant of the brewing unit of FIGS. 1-2;

FIG. 4 is a view of the brewing unit of FIG. 2 with separated components, in which the first piston is partly sectioned to show the path of the “Espresso” type coffee beverage;

FIG. 4a shows the first piston of FIG. 4 partly sectioned according to another section plane to show the path of the “Drip” type coffee beverage;

FIGS. 5-6 are partly sectioned three-dimensional views of the brewing unit which show the path of the “Espresso” (FIG. 5) and “Drip” type coffee beverage (FIG. 6), respectively;

FIG. 7 is a top plan view of the first piston;

FIGS. 8 and 9 are section views of the first piston of FIG. 7 along section lines VIII-VIII (FIG. 8) and IX-IX (FIG. 9), respectively;

FIG. 10 is a lateral view of the brewing unit;

FIGS. 11 and 12 are section views of the brewing unit of FIG. 10 along section lines XI-XI (FIG. 11) and XII-XII (FIG. 12);

FIGS. 13-14 are three-dimensional views of a machine for preparing coffee according to the present invention.

We must clarify that the phraseology and terminology used in the present description, as well as the figures in the attached drawings also in relation as to how described, have the sole function of better illustrating and explaining the present invention, their purpose being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

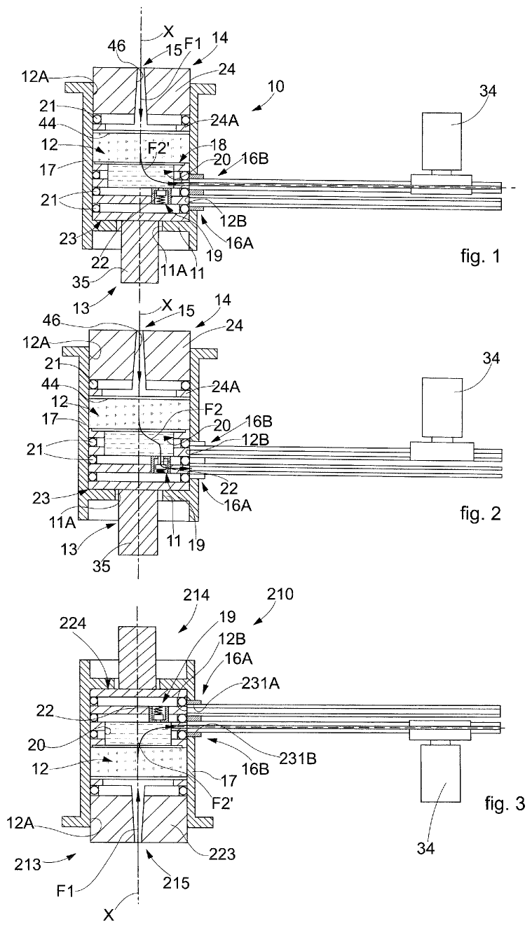

With reference to FIGS. 1-2, a brewing unit 10 is shown schematically, configured to selectively make available a coffee beverage both at low pressure, without the presence of cream, as required for the preparation of a “Drip” type coffee beverage, and also under pressure, with the presence of cream, that is, beverages with the organoleptic characteristics of an “Espresso” type coffee beverage.

The brewing unit 10 comprises an open brewing chamber 12, suitable to contain a dose of coffee powder to be subjected to brewing.

The brewing chamber 12 is generally open and is closed at the bottom by a first piston 13.

The brewing chamber 12 can be defined by a body with a tubular shape, preferably cylindrical with a circular section, although different conformations with an oval or polygonal section can also be provided.

The first piston 13 is preferably disposed sliding inside the brewing chamber 12 along a longitudinal axis X thereof.

The first piston 13 comprises a head portion 23 disposed inside the brewing chamber 12, and a rod 35 which is guided sliding in a through hole 11A of a bottom wall 11 of the brewing chamber 12 and extends from the external side of the bottom wall 11.

The head portion 23 is provided with perimeter seals 21 suitable to cooperate with the lateral wall(s) 17 of the brewing chamber 12 to obtain a hydraulic seal therewith.

The brewing unit 10 further comprises a second piston 14 configured to engage with the brewing chamber 12 on the opposite side with respect to the first piston 13 and close it at the top.

According to some embodiments, the brewing chamber 12 together with the first piston 13 define a mobile extraction assembly, and cooperate with the second piston 14 in correspondence with a brewing zone of a machine 100 for preparing coffee beverages.

The brewing chamber 12 and the first piston 13 are integral with each other and can be moved together as a single body.

The second piston 14 comprises a head portion 24 disposed, during use, inside the brewing chamber 12 and sliding along the longitudinal axis X.

The head portion 24 is provided with perimeter seals 21 suitable to cooperate with the lateral wall(s) 17 of the brewing chamber 12 to obtain a hydraulic seal.

The brewing unit 10 comprises an inlet duct 15 for the heated water, communicating with an inlet end 12A of the brewing chamber 12. The inlet duct 15, during use, is connected to a tank, or other water feed source, not shown.

According to one aspect of the present invention, the brewing unit 10 further comprises a valve 19, known to the people of skill in the art by the term “cream frother valve”, housed in a seating 22 provided in the head portion 23 of the first piston 13. Therefore, the valve 19 is an integral part of the brewing unit 10, in particular of the first piston 13.

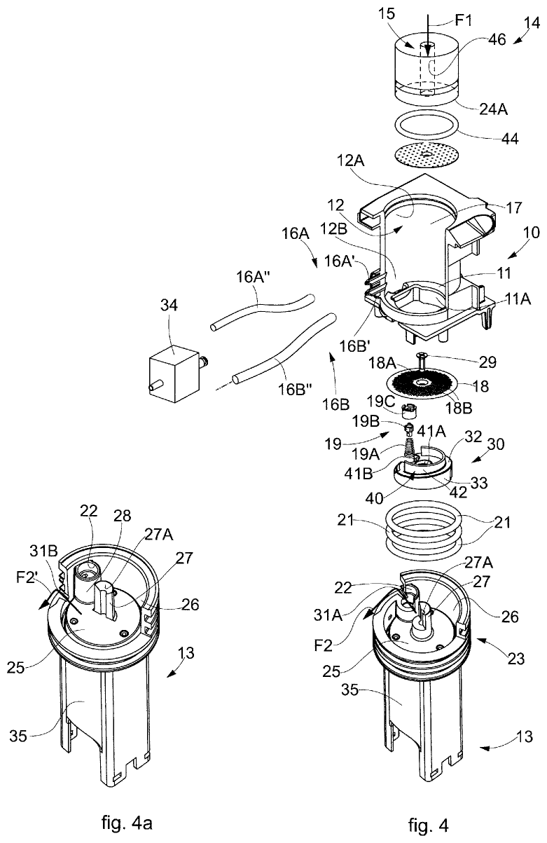

The valve 19 can comprise a spring 19A with which a first shutter element 19B and a second shutter element 19C are associated, FIG. 4.

The valve 19 is configured to allow the transit of the beverage through it only if the pressure exceeds a defined threshold value, to obtain a beverage with the organoleptic characteristics similar to an “Espresso” type coffee.

By way of example, the valve 19 can be configured to counteract a maximum pressure of about 4 bar, preferably comprised between 1 and 4 bar.

With reference to FIGS. 1-2, the valve 19 is communicating fluidically both with the brewing chamber 12, to receive the coffee beverage, and also with a first outlet duct 16A, to transfer the coffee beverage downstream. In other words, the valve 19 is interposed between the brewing chamber 12 and the first outlet duct 16A. The first outlet duct 16A is dedicated only to the transfer of the “Espresso” type coffee beverage.

A distinct second outlet duct 16B is communicating fluidically with the brewing chamber 12 and along it there is associated an on-off valve 34 external to the brewing unit 10. The second outlet duct 16B is dedicated only to the transfer of the “Drip” type coffee beverage.

The on-off valve 34 can be, for example, a solenoid valve configured to be commanded in order to open and close the second outlet duct 16B determining a preferential path for the coffee beverage.

Therefore, when the on-off valve 34 is open, the “Drip” coffee beverage flows through the second outlet duct 16B because the pressure induced inside the brewing chamber 12 is not such as to determine the opening of the valve 19.

If the on-off valve 34 is closed, the pressure of the coffee beverage increases until it opens the valve 19 through which it passes to flow in the first outlet duct 16A.

The outlet ducts 16, during use, connect to a beverage dispensing nozzle, not shown.

According to some embodiments, the outlet ducts 16A, 16B advantageously comprise a respective flanged portion 16A′, 16B′ developing from the lateral wall 17 of the brewing chamber and a respective elongated portion 16A″, 16B″ connected on one side to the delivery nozzle and on the other side, preferably removably, to the corresponding flanged portion 16A′, 16B′, FIG. 4.

According to the embodiment described with reference to FIGS. 1-2 and 4-4a, the inlet duct 15 is at least partly made through in the second piston 14. The outlet ducts 16A, 16B are at least partly made through in both the first piston 13 and also in the lateral wall 17 of the brewing chamber 12.

In this case, the flow of the water follows a direction from top to bottom, in the direction indicated by the arrows F1, while the coffee beverage follows a substantially radial direction F2 (“Espresso”) and F2′ (“Drip”), and possibly partly tangential, through the first piston 13 and the lateral wall 17 of the brewing chamber 12 through one or the other outlet duct 16A, 16B.

At least one water feed channel 46 is made in the second piston 14, which defines the terminal portion of the inlet duct 15 upstream of the brewing chamber 12.

According to some embodiments, in correspondence with one end 24A of the head portion 24 of the second piston 14 there is disposed a perforated element 44 through which the water coming from the feed duct 46 is diffused on top of the coffee powder, so as to distribute it in a homogeneous and uniform manner, FIGS. 1-2 and 4.

The brewing unit 10 comprises a filtering element 18 disposed, during use, in the brewing chamber 12, in correspondence with the end facing toward the outlet ducts 16A, 16B, and provided with a plurality of through holes 18B, FIGS. 1-2 and 4-9. These through holes 18B have a diameter suitable to allow the passage of the coffee beverage through them, and at the same time prevent the transit of wet or dry coffee powder.

The brewing unit 10 comprises a decantation chamber 20, disposed between the filtering element 18 and the outlet ducts 16A, 16B and configured to allow an accumulation therein of the coffee beverage and slow down its flow toward the outlet ducts 16A, 16B, FIGS. 1-2, 5-6, 8-9.

Especially for the preparation of “Drip” type coffee, any air bubbles in the coffee beverage, which could involve the presence of foam in the beverage dispensed, have time to disperse and dissolve, so the coffee beverage that is dispensed from the dispensing nozzle has characteristics comparable to those of a beverage obtained by means of percolation in a traditional type “drip” machine. Any air bubbles present could also create local variations in the pressure of the coffee beverage that could alter the correct operation of the valve 19 if dispensing an “Espresso” type coffee beverage.

According to some embodiments, with reference to FIGS. 1-2, 4, 4a, 8-9, the decantation chamber 20 is created inside the head portion 23 of the first piston 13, which is therefore at least partly hollow.

In particular, the head portion 23 is open at the top and closed by means of the filtering element 18.

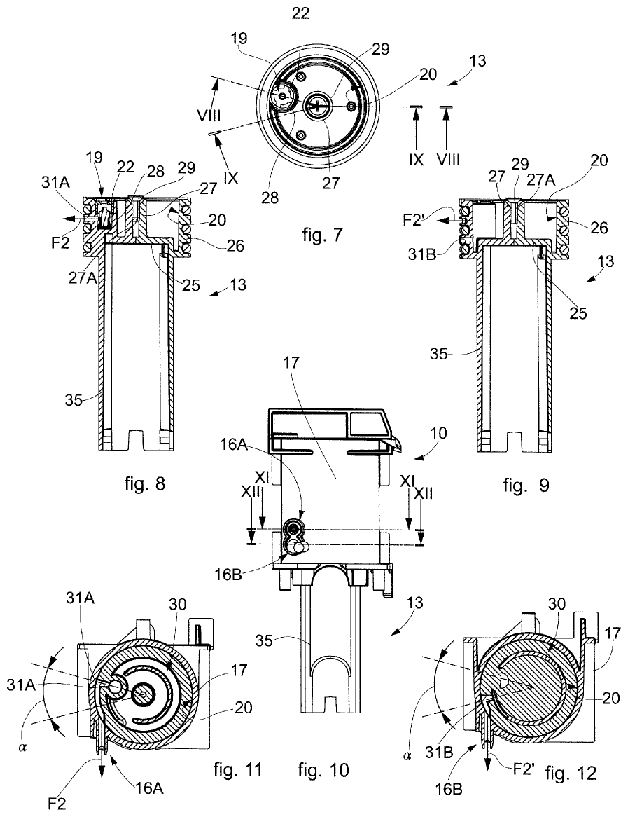

According to some embodiments, the head portion 23 has a cup shape, defined by a bottom wall 25 and by one or more lateral walls 26, which delimit the decantation chamber 20, FIGS. 4 and 4a. The decantation chamber 20 is delimited at the top by the filtering element 18, FIGS. 8-9.

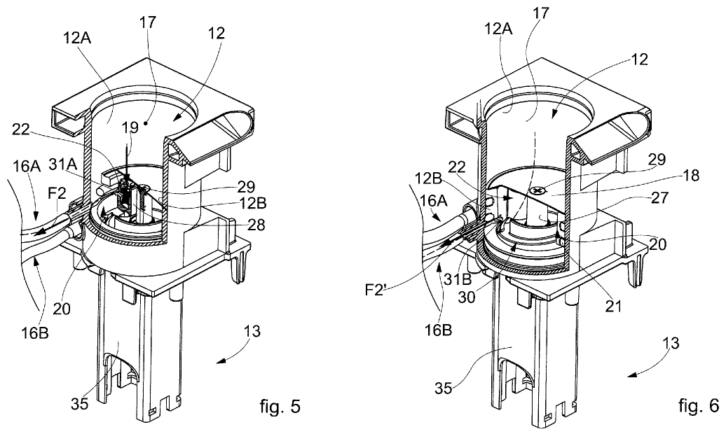

According to some embodiments, the filtering element 18 is positioned on the upper edge of the lateral walls 26, FIGS. 5-8.

The head portion 23 can comprise a support portion 27 protruding from a central zone of the bottom wall 25, having a height consistent with that of the lateral wall(s) 26.

This support portion 27 is configured to support the filtering element 18 in the central zone, so as to prevent any deformations thereof during the operations of compressing and subsequently expelling the exhausted coffee powder.

In fact, in order to adequately compress the exhausted coffee powder and make the residual water come out, a high compression force is necessary, in the order of 0.2-0.5 kg/cm² and therefore, if not correctly supported, the filtering element 18, being distanced from the bottom wall 25, could be deformed by the contrast with the coffee powder.

The support portion 27 can have a cavity 27A, possibly threaded, in which an attachment member 29, for example a screw, can be inserted to attach the filtering element 18, passing through a through aperture 18A made therein.

According to some embodiments, the seating 22 is positioned in the decantation chamber 20 in correspondence with a peripheral zone of the bottom wall 25, and it is conformed to house the valve 19, FIGS. 4, 4a, 5, 8 and 11.

The seating 22 is open in at least two directions so as to allow the passage of the coffee beverage from the decantation chamber 20 through the valve 19 toward the first outlet duct 16A. The seating 22 is open at the top in the direction of the filtering element 18.

According to possible embodiments, the seating 22 can have an essentially hollow cylindrical or truncated conical shape. However, a person of skill in the art will understand that the shape of the seating 22 essentially mates with the shape of the valve 19, therefore it can also be different from the hollow cylindrical or truncated conical one.

The seating 22 is preferably made in one piece, that is, in a single body, with the head portion 23.

According to a variant not shown, the seating 22 can be made as a distinct component, associated with the head portion 23 by means of a press-fit type coupling, interlocking coupling, or by using mechanical attachment members such as screws, or other.

According to some embodiments, the seating 22 is made in the body of the head portion 23, flush with the bottom wall 25 of the decantation chamber 20, FIGS. 1-2. In other words, the seating 22 is lowered with respect to the bottom wall 25 and is made in the thickness thereof.

According to other embodiments, with reference to FIGS. 4 and 4a, the seating 22 can be made protruding from a peripheral zone of the bottom wall 25, with a height only slightly lower than that of the lateral wall(s) 26. The seating 22 also has a height only slightly lower than the support portion 27.

With reference to FIG. 8, the seating 22 can be defined at the bottom by the bottom wall 25 of the decantation chamber 20 and laterally by a containing wall 28. The containing wall 28 can be at least partly incorporated in the lateral wall 26 of the decantation chamber 20, as visible in FIG. 4a for example.

According to other embodiments, the containing wall 28 can fully define the seating 22 and can be distanced from the lateral wall 26 of the decantation chamber 20.

According to some embodiments, both outlet ducts 16A, 16B communicate with the decantation chamber 20 by means of respective outlet apertures 31A, 31B made through in one of the walls 25, 26 of the head portion 23 of the first piston 13 and through the lateral wall 17 of the brewing chamber 12, FIGS. 8-9, 11-12.

The outlet apertures 31A, 31B are preferably made passing through the lateral wall 26 of the head portion 23 of the first piston 13.

The first outlet duct 16A communicates with the decantation chamber 20 through a first outlet aperture 31A, open toward the seating 22 in which the valve 19 is housed, FIG. 8.

The second outlet duct 16B communicates directly with the decantation chamber 20 through a second outlet aperture 31B distinct from the first outlet aperture 31A, FIG. 8.

The outlet apertures 31A, 31B are made offset in a direction parallel to the longitudinal axis X, for example at different distances from the bottom wall 25 or from the filtering element 18. In other words, the outlet apertures 31A, 31B are disposed in such a way as to be misaligned in a direction parallel to the longitudinal axis X.

According to the embodiments of FIGS. 1-2, the first outlet aperture 31A is located at a lower height than the second outlet aperture 31B. In this case, the apertures 31A, 31B are made substantially “straddling” a base surface of the bottom wall 25 that is substantially intermediate between them. The first outlet aperture 31A is at least partly recessed, that is, made, in the bottom wall 25.

According to other embodiments of FIGS. 8-9, both apertures 31A, 31B are disposed between the bottom wall 25 and the filtering element 18. The first outlet aperture 31A is located at a distance from the bottom wall 25 greater than the distance at which the second outlet aperture 13B is located.

In particular, the first outlet aperture 31A is substantially intermediate between the bottom wall 25 and the filtering element 18, while the second outlet aperture 31B is substantially at the same height or slightly lowered with respect to the bottom wall 25.

The outlet apertures 31A, 31B are preferably made angularly offset by an offset angle α comprised between about 1-2° and about 180° (opposed positioning).

According to possible embodiments, the offset angle α can be comprised between about 5° and about 120°, even more preferably comprised between about 10° and about 90°.

Referring to FIGS. 11-12, the offset angle α is comprised between about 10° and about 50°, for example roughly about 30°.

With reference to FIGS. 11-12, the outlet apertures 31A, 31B preferably have a direction of development with a first substantially radial segment and a second substantially tangential segment. The second substantially tangential segment extends through the lateral wall 17 of the brewing chamber 12 toward the respective outlet ducts 16A, 16B.

According to some embodiments, the bottom wall 25 can have a flat shape, substantially parallel to a horizontal plane, or it can be inclined with respect thereto at least toward the second outlet aperture 31B in order to convey the coffee beverage toward it.

According to possible variants, described for example with reference to FIGS. 4-6, the brewing unit 10 can comprise an insert 30 configured to be positioned, during use, in the decantation chamber 20, and having the purpose of conveying the flow of the coffee beverage so as to divert it and make it follow an indirect path at least toward the second outlet aperture 31B. In this way, if the coffee beverage comprises air bubbles, these have time to dissolve and disperse before the beverage exits the brewing unit 10.

According to some embodiments, the insert 30 has a plan shape mating with the shape of the section of the decantation chamber 20 and comprises an upper wall 32, preferably inclined toward the outlet apertures 31A, 31B, in particular toward the second outlet aperture 31B, and support walls 33 configured to cooperate with the bottom wall 25.

According to some embodiments, in the upper wall 32 there is a central through slot 41A suitable to allow the passage of the support portion 27, and a peripheral through slot 41B suitable to allow the passage of the seating 22.

The insert 30 can comprises diverting members 40 extending from the upper surface 32, configured to divert the path of the beverage's flow, preventing it from flowing directly toward the outlet aperture 31B. This allows to further reduce the possibility of residual air bubbles in the coffee beverage.

The diverting members 40 can comprise at least one annular protrusion 42, open, during use, toward the second outlet aperture 31B and toward the seating 22.

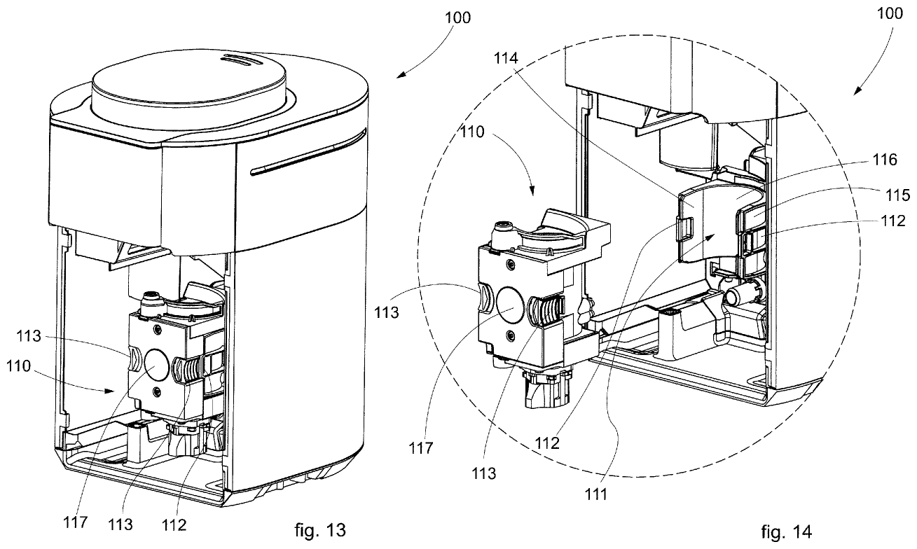

With reference to FIGS. 13-14, an automatic machine 100 for preparing “Drip” type and “Espresso” type coffee beverages is shown. The machine 100 comprises a unit for feeding coffee powder, a brewing unit 10, a water feed source connected to the inlet duct of the brewing unit 10 and a beverage dispensing nozzle connected to the outlet ducts 16A, 16B.

The machine 100 comprises a housing 111 configured to removably receive an extraction assembly 110 formed by the brewing chamber 12 and by the first piston 13 in which the valve 19 is housed.

The housing 111 is provided with first coupling members 112 and the extraction assembly 110 is provided with second coupling members 113, associated with an external wall of the brewing chamber 12, configured to cooperate with each other to guarantee a releasable positioning of the extraction assembly.

The housing 111 is formed by a U-shaped structure, open frontally, with two lateral arms 114, 115 facing each other and on which the first coupling members 112 are provided, and a connection wall 116 between the lateral arms 114, 115 in which the attachments for the flanged portions 16A′, 16B′ of the outlet ducts 16A, 16B are provided.

The integration of the extraction components, including the valve 19, the filtering element 18, the decantation chamber 20, the outlet apertures 31A, 31B and the flanged portions of the outlet ducts 16A, 16B, in the first piston 13 and in the brewing chamber 12 allows to completely remove the extraction assembly 110 allowing it to be cleaned.

The coupling members 112, 113 can comprise elastic fins that determine a “snap-in” type connection.

A release member 117 can be associated with the body of the brewing chamber 12 or with the housing 111 to disengage the second coupling members 113 from the first coupling members 112 and allow the removal of the extraction assembly 110. According to a variant, the release member 117 can be associated with the housing 111 or with another fixed part of the machine 100.

The release member 117 can be, for example, a manually activated button.

The release member 117 can be configured to act on the first coupling means 112 directly or by means of intermediate mechanisms in order to disengage the first coupling means 112 from the second coupling means 113.

It is clear that modifications and/or additions of parts may be made to the brewing unit for a machine for preparing coffee and corresponding machine as described heretofore, without departing from the field and scope of the present invention, as defined by the claims.

With reference to FIG. 3, there is described a brewing unit 210 in accordance with a second embodiment. The elements common to the first embodiment shown in FIGS. 1-2 are indicated with the same numbers; while corresponding but different elements are indicated with the numbers used in FIGS. 1-2, increased by 200.

The brewing unit 210 comprises a brewing chamber 12 closed at the bottom by a first piston 213 and at the top, on the opposite side, by a second piston 214, and an inlet duct 215 for the heated water communicating with an inlet side 12A of the brewing chamber 12. The inlet duct 215 is made on the first piston 213, in particular through the head portion 223.

The valve 19 is housed in a seating 22 provided in the decantation chamber 20 which is made in the head portion 224 of the second piston 214. The outlet apertures 231A, 231B are made passing through the second piston 214 and the lateral wall 17 of the brewing chamber 12. In this case, the water and the coffee beverage flow from the bottom upward through one or the other outlet duct 16A, 16B which are connected to the respective outlet apertures 231A, 231B.

It is also clear that, although the present invention has been described with reference to some specific examples, a person of skill in the art will be able to achieve other equivalent forms of a brewing unit for a machine for preparing coffee and corresponding machine, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. A brewing unit for an automatic machine for preparing coffee beverages, comprising a brewing chamber closed at the bottom by a first piston and at the top, on the opposite side, by a second piston, and an inlet duct for the heated water communicating with an inlet side of said brewing chamber, wherein, said brewing unit comprises a valve housed inside said first piston or said second piston, and two distinct outlet ducts communicating with an outlet side of said brewing chamber, wherein a first outlet duct is fluidically connected to said valve and a second outlet duct is fluidically connected to an on-off valve external to said brewing chamber.

2. The brewing unit according to claim 1, wherein said brewing unit comprises a decantation chamber created inside a head portion of said first piston and configured to house a seating in which said valve is contained.

3. The brewing unit according to claim 2, wherein said outlet ducts communicate with said decantation chamber by means of respective outlet apertures made through in one of the walls (25, 26) of the head portion of said first piston and in a lateral wall of said brewing chamber (12), wherein a first outlet aperture communicates with said decantation chamber by means of said valve, wherein said second outlet aperture communicates directly with said decantation chamber.

4. The brewing unit according to claim 3, wherein said outlet apertures are located at different distances from a bottom wall of said head portion.

5. The brewing unit according to claim 4, wherein said first outlet aperture is located at a greater distance from said bottom wall than the distance which said second outlet aperture is located from said bottom wall.

6. The brewing unit according to claim 3, wherein said outlet apertures are made angularly offset with respect to each other by an offset angle (α) comprised between 1-2° and 180°, more preferably comprised between 5° and 120°.

7. The brewing unit according to claim 4, wherein said seating is made protruding from a peripheral zone of said bottom wall, with a height only slightly lower than that of a lateral wall of said head portion.

8. The brewing unit according to claim 1, wherein said brewing unit comprises a decantation chamber made in a head portion of said second piston and said valve is housed in a seating provided in the decantation chamber.

9. The brewing unit according to claim 8, wherein said outlet ducts communicate with said decantation chamber by means of respective outlet apertures made passing through the second piston and a lateral wall of said brewing chamber, wherein a first outlet aperture communicates with said decantation chamber by means of said valve and a second outlet aperture communicates directly with said decantation chamber.

10. An automatic machine for preparing coffee beverages, comprising a unit for feeding coffee powder, a brewing unit as in any claim hereinbefore, a water feed source connected to said inlet duct and a beverage dispensing nozzle connected to said outlet ducts.

11. The machine according to claim 10, wherein said machine comprises a housing configured to receive in a removable manner an extraction assembly formed by said brewing chamber and said first piston in which said valve is housed.

12. The machine according to claim 11, wherein said housing is provided with first coupling members and said extraction assembly is provided with second coupling members, associated with an external wall of said brewing chamber, configured to cooperate with each other in order to guarantee a releasable positioning of said extraction assembly.
